(19) United States
(12) Patent Application Publication
(10) Pub. No.: US 2011/0248098 A1
(43) Pub. Date: Oct. 13, 2011

(54) PORTABLE FAUCET SPRAYER

(76) Inventor: ROBERT JOHN KOPKE, BOISE, ID (US)

(21) Appl. No.: 12/757,034

(22) Filed: Apr. 8, 2010

(51) Int. Cl. A62C 31/28

(52) U.S. Cl. 239/274

(57) ABSTRACT

The present invention is a plumbing accessory having a sprayer valve, hose and connector assembly which conveniently connects to the aerator threads on a sink faucet. The connector provides a swivel connection during attachment so the assembly may be attached without twisting the hose. The present connector comprises three parts. First, there is a generally cylindrical, hollow basket-like or cup-like structure which is threaded at its open top end, preferably both on the inside and outside perimeters. The bottom end of the cup is closed except for a central, generally circular orifice. Second, there is a generally cylindrical insert structure which fits smoothly, but not loosely inside the cup. The insert has a flat bottom which rests upon the top of the bottom closed end of the cup. The insert is also generally hollow, providing a central opening which extends from near the open top of the inside of the cup through its closed bottom. At the bottom of the insert is a generally cylindrical, hollow extension, which projects down through the orifice in the bottom of the cup. The distal end of the extension, preferably with stepped outside edges, is adapted for fitting into the proximal end of a plastic or rubber hose in conventional fashion. Third, there is a generally cylindrical sealer washer which also fits inside the cup, and rests smoothly, but not loosely, on top of the insert. The sealer washer also has a central, generally circular orifice which is generally co-extensive with the central opening in the top of the insert.

### BACKGROUND OF THE INVENTION

1. Field of the Invention

This invention relates generally to plumbing fixtures and accessories. More specifically, this invention relates to a water sprayer valve, hose and connector assembly which may be easily connected to, and disconnected from, the aerator threads on a faucet, for example, in a sink.

2. Related Art

The following U.S. patents Numbers disclose different sprayer assemblies and faucet and hose connections:
U.S. Pat. No. 4,018,460 (Morris, et al.);
U.S. Pat. No. 4,477,109 (Kleuver);
U.S. Pat. No. 5,024,419 (Mulvey);
U.S. Pat. No. 6,485,064 (Davidson);
Published Application US 2003/0042337 (Liang, et al);
U.S. Pat. No. 6,704,946 (Mueller, et al);
Published Application US 2005/0280260 (Lu);
Published Application US 2008/0001009 (Young); and,
D544,572 (De Alba)

In addition, Waxman Consumer Group (Cleveland, Ohio, USA—item #76-357) and Danco Company (Irving, Tex., USA—item #16560) have commercially available sink sprayer and hose assemblies. These are similar to the “prior art” version of FIG. 1 discussed in the Lu reference, above. Furthermore, Idea Factory, Inc. (Menomonee Falls, Wis., USA—the RINSE ACE® POWER SPRAYER™) has commercially available a choice of diverter valves for a quick-connectable and detachable hose with sprayer.

### SUMMARY OF THE INVENTION

The present invention is a plumbing accessory having a sprayer valve, hose and connector assembly which conveniently connects to a sink faucet. The hose connection is adapted to screw into the inside threads for an aerator of a faucet head on a faucet type with the threads for the aerator on the inside. Also, the hose connection may be adapted to screw onto the outside threads for an aerator of a faucet head on a faucet type with the threads on the outside. The connector is preferably commercially provided with dual threading and appropriate sealer washers to fit both of the above types of faucets—inside threaded or outside threaded. When the invention is disconnected, the aerator may be re-installed.

The invention is a device that provides a controlled source of water to a distant point through a connector/hose/sprayer assembly that attaches to the faucet aerator threads after the aerator has been removed. The connector provides a swivel connection during attachment so the assembly may be attached without twisting the hose. After the hose is securely attached, it does not swivel. Preferably, the bottom of the connector is knurled or faceted with straight edges in an octagon or hexagon manner, for example, which allows for a convenient hand-tight-water-tight connection to the aerator threads of the faucet. Likewise, this construction of the bottom of the connector also allows for a convenient hand-twist for disconnection from the faucet. This results in a portable hose connection and water sprayer valve assembly. Also preferably, the top of the connector is threaded on both the inside and the outside to fit both types of faucet aerator connections—inside threaded or outside threaded with one model of connector. Alternatively, the top of the connector in one model style may be threaded on the inside to fit an outside threaded type of faucet, and in another model style threaded on the outside to fit an inside threaded type of faucet.

The present connector comprises three parts. First, there is a generally cylindrical, hollow basket-like or cup-like structure which is threaded at its open top end, preferably both on the inside and outside perimeters. This is where the cup connects to the faucet threads for the aerator. The bottom end of the cup is closed except for a central, generally circular orifice.

Second, there is a generally cylindrical insert structure which fits smoothly, but not loosely, inside the cup. The insert has a flat bottom which rests upon the top of the bottom closed end of the cup. The insert is also generally hollow, providing a central opening which extends from near the open top of the inside of the cup through its closed bottom. At the bottom of the insert is a generally cylindrical, hollow extension, which projects down through the orifice in the bottom of the cup. The distal end of the extension, preferably with stepped outside edges, is adapted for fitting into the proximal end of a plastic or rubber hose in conventional fashion. This way, a hose may be conveniently secured on the hose's proximal end onto or into the distal end of a faucet where the aerator threads are located, and conveniently provide, for example, a sprayer valve mechanism on the hose's distal end in conventional manner.

Third, there is a generally cylindrical sealer washer which also fits inside the cup, and rests smoothly, but not loosely, on top of the insert. The sealer washer also has a central, generally circular orifice which is generally co-extensive with the central opening in the top of the insert. This way, the sealer washer and the hollow central part of the insert provide a central opening for water to flow through the center of the connector, and a peripheral seal to prevent water leakage around the outside of the insert. It is important that the sealer washer extend from the top of the insert to the bottom surface of the faucet distal end where the aerator threads are located. This way, as the cup is engaged on the threads for the aerator and rotated to tighten, the bottom of the cup moves up, and moves the insert and the sealer washer up also to contact and be compressed by the bottom surface of faucet distal end, and thereby a secure seal is created. Therefore, for the embodiment of the present invention wherein the faucet distal end is inside threaded, the sealer washer needs to be thicker than in the embodiment wherein the faucet distal end is outside threaded.

### BRIEF DESCRIPTION OF THE DRAWINGS

FIG. 1 is a side, perspective view of one embodiment of the invention connected to the inside aerator threads of a sink faucet.

FIG. 2 is a partial, side cross-sectional view of the embodiment depicted in FIG. 1.

FIG. 3 is a partial, exploded view of the view depicted in FIG. 1.

FIG. 4 is a side, perspective view of another embodiment of the invention connected to the outside aerator threads of a sink faucet.

FIG. 5 is a partial, side cross-sectional view of the embodiment depicted in FIG. 4.

FIG. 6 is a top, perspective view of the cup-like structure part of the invention.

FIG. 7 is an upside-down, perspective view of the view depicted in FIG. 6.

FIG. 8 is a top, perspective view of the insert structure part of the invention.

FIG. 9 is an upside-down perspective view of the view depicted in FIG. 8.

FIG. 10 is a top view of one embodiment of the invention, with the sealer washer and the insert structure nested above and within the cup-like structure.

FIG. 11 is a side, cross-sectional view taken along the line indicated in FIG. 10.

FIG. 12 is a perspective view of one embodiment of the invention set up in a bathroom with a sink and a tub/shower.

### DETAILED DESCRIPTION OF THE INVENTION

Referring to the Figures, there are depicted several, but not all, embodiments of the present invention.

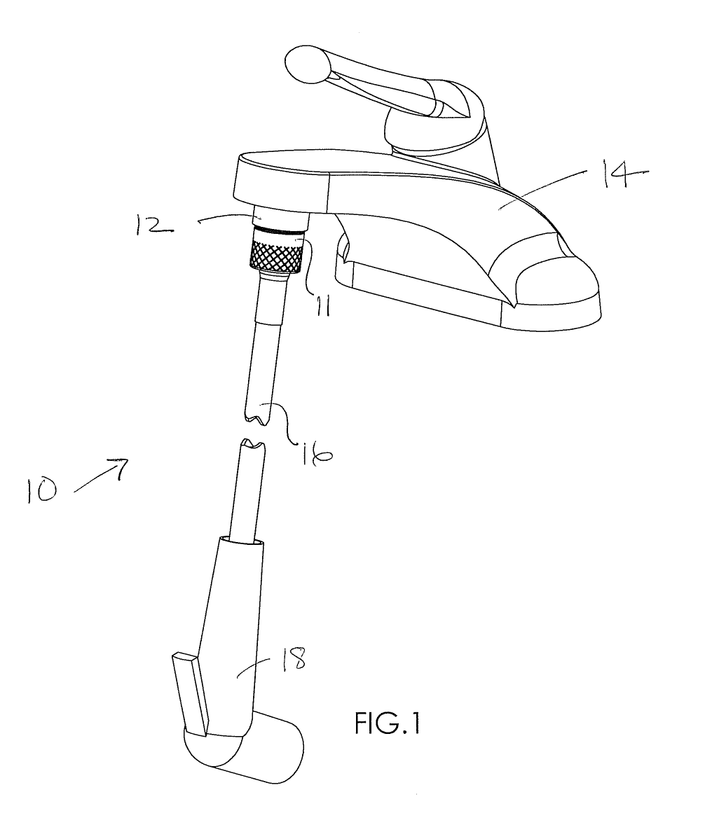

In FIG. 1, there is depicted a side, perspective view of one embodiment of the portable faucet sprayer 10 of the invention. Connector 11 of sprayer 10 is threaded into the inside aerator threads (not shown) of the distal end 12 of sink faucet 14 by the threads on connector 11's top, outside perimeter. Connector 11 connects hose 16 at its proximal end to sink faucet 14 via the faucet's distal end 12. At the distal end of hose 16 is preferably connected sprayer valve assembly 18.

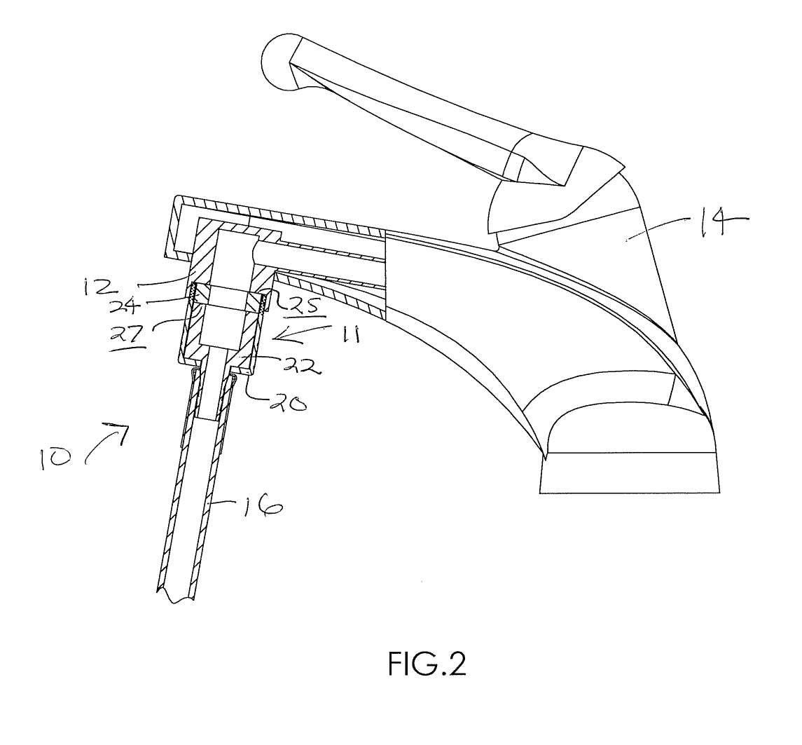

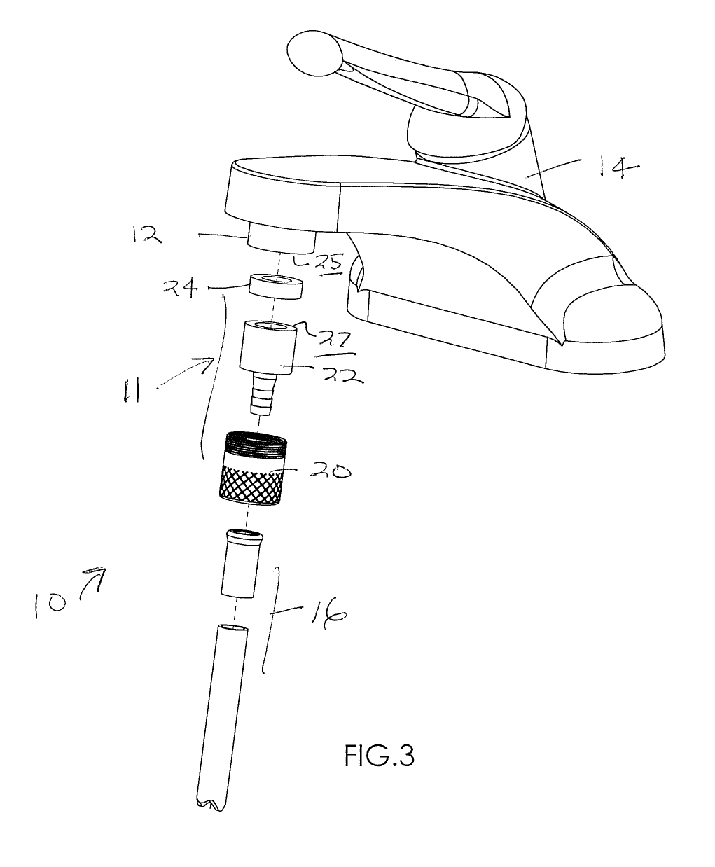

A partial, side cross-sectional view of the embodiment depicted in FIG. 1 is depicted in FIG. 2. In FIG. 2, the outer cup-like structure 20, and the inner insert structure 22 surrounded by the cup-like structure 20 are also clearly visible in this Figure. Also visible in FIG. 2 is a first, thicker sealer washer 24 which helps create a good seal between the connector 11 of the invention and the sink faucet. Sealer washer 24 fits snugly between the bottom surface 25 of the faucet distal end 12, and the top surface 27 of the inner insert 22. This way, a convenient hand-tight-water-tight connection may be made between connector 11, the inside aerator threads, and the distal end 12 of the faucet 14. The water-tight seal is made by the upward pressure of insert 22 against the distal end 12 which compresses sealer washer 24 longitudinally, and expands it radially against the inner wall of outer cup-like structure 20. These pieces parts are shown in exploded view fashion in FIG. 3.

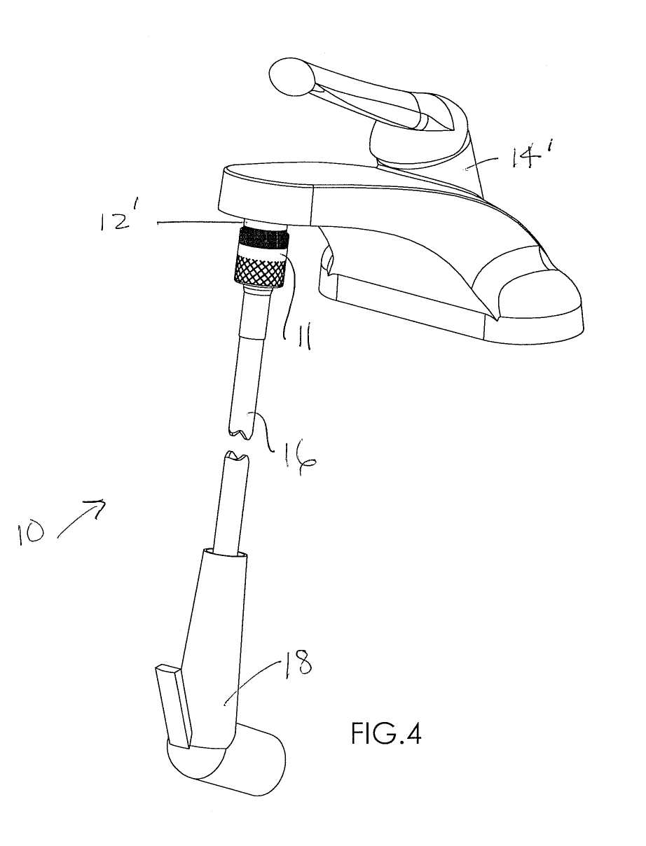

In FIG. 4 is depicted a side, perspective view of another embodiment of the portable faucet sprayer 10 of the invention. Connector 11 of sprayer 10 is threaded onto the outer aerator threads (not shown) of the distal end 12′ of sink faucet 14′. This way, connector 11 is secured by the threads on its top, inside perimeter. Again, connector 11 enables hose 16 to be conveniently connected on its proximal end to the distal end 12′ of faucet 14′, and connects to, for example, a sprayer valve assembly 18 at the hose's distal end.

A partial, side cross-sectional view of the embodiment depicted in FIG. 4 is depicted in FIG. 5. The outer cup-like structure 20, and the inner insert structure 22 surrounded by the cup-like structure 20 are also clearly visible in this Figure. In this embodiment, a different, thinner sealer washer 24′ is required in order to ensure the seal between connector 11 and faucet 14′ via its distal end 12′. Again, sealer washer 24′ fits snugly between the bottom surface 25′ of the faucet distal end 12′, and the top surface 27′ of the inner insert 22. Again, this way a convenient hand-tight-water-tight connection may be made between connector 11, the outside aerator threads, and the distal end 12′ of the faucet 14′. Preferably, the dimensions and fit of connector 11, including outer cup 20 and inner insert 22, are designed and manufactured so that thicker sealer washer 24 is about exactly twice the thickness of thinner sealer washer 24′. This way, in a commercial package, two (2) thinner sealer washers 24′ may be provided, and both installed to become the same as thicker washer 24. Optionally sealer washers 24 and 24′ may have flat top surfaces, or top surfaces with an annular groove.

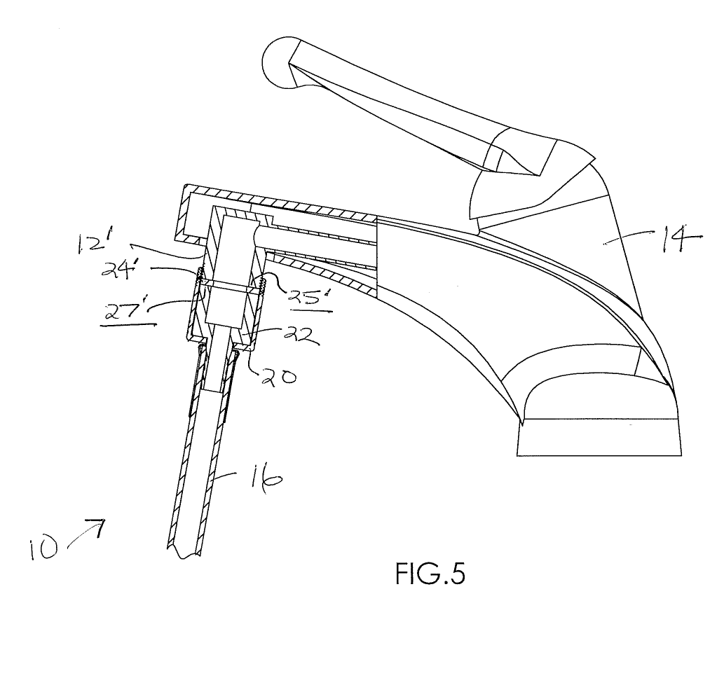

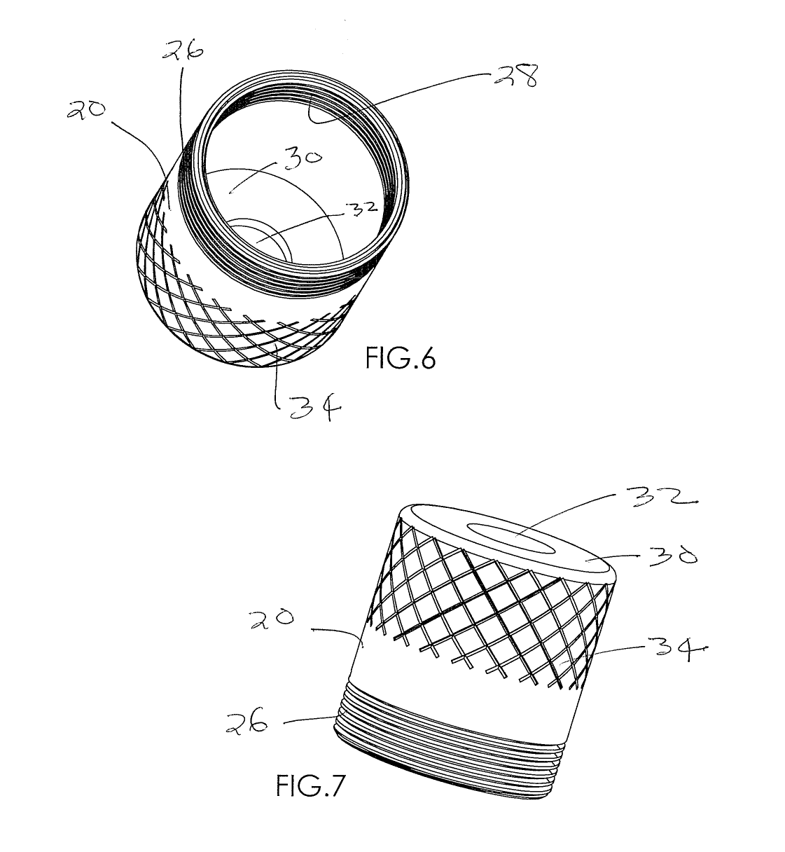

In FIGS. 6 and 7 are depicted two views of the cup-like structure part 20 of the connector 11 of the invention. Cup 20 has outside threads 26 and inside threads 28 at its top perimeter. Cup 20 has flat closed bottom 30, except for circular central aperture 32. Optionally, cup 20 has a knurled outer surface at the lower edge thereof for ease of turning it by hand to install and remove it from the faucet aerator threads.

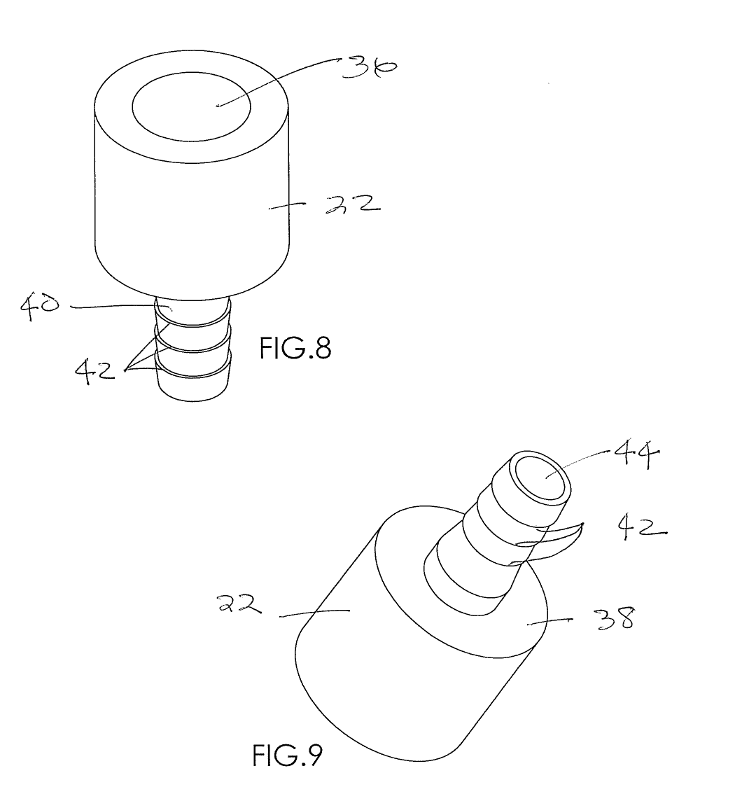

FIGS. 8 and 9 are different views of the inner insert structure part 22 of the connector 11 of the invention. Insert 22 is generally hollow and cylindrical, and fits inside cup 20. Insert 22 has central opening 36 at its top end, and flat resting surface 38 at its bottom end. Insert 22 has a generally hollow, cylindrical extension 40 extending from its bottom end. Extension 40 preferably has stepped outside edges 42 which assist in a tight fit between extension 40 and hose 16 which are interconnected by conventional technique. At the distal end of extension 40 is opening 44 which extends through the center of extension 40 and up into central opening 36. This way, a continuous open passageway for water flow is provided all the way through connector 11 of the invention when insert 22 is nested within cup-like structure 20 and covered by sealer washer 24 or 24′.

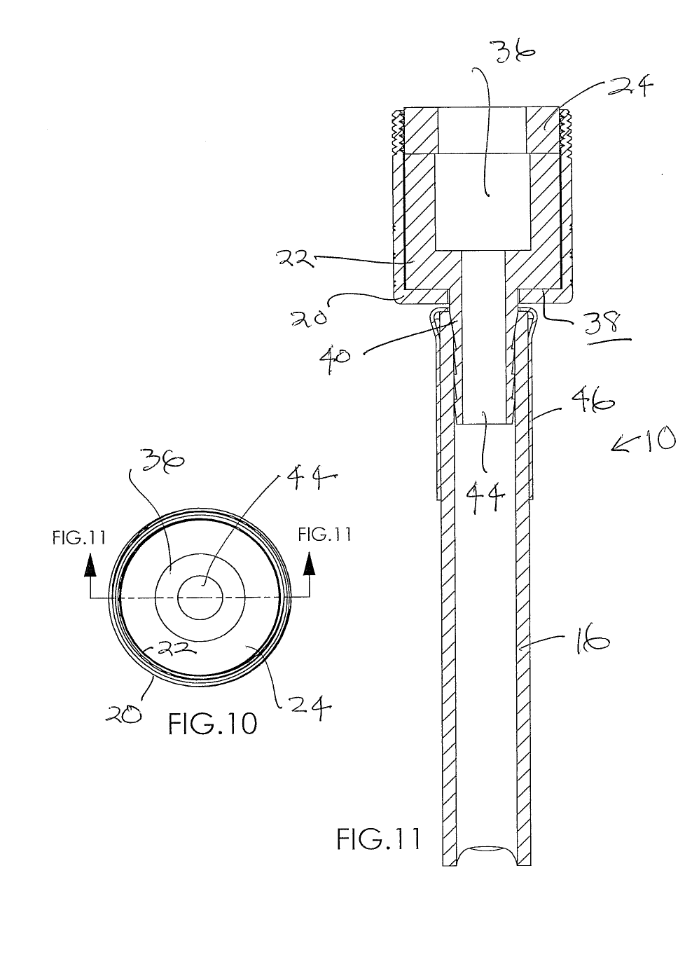

FIG. 10 is a top view of connector 11 with outer cup structure 20 surrounding inner insert 22 which supports thicker washer 24. The common passageway which is the combinations of openings 36 and 44 is also clearly visible in this Figure.

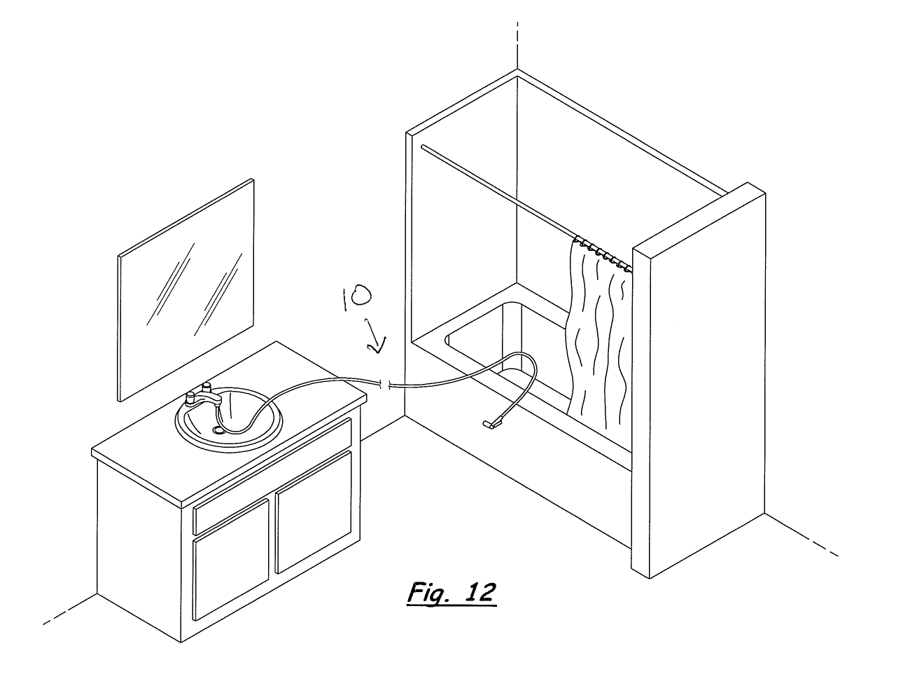

In FIG. 11 is depicted a side, cross-sectional view along the line 11-11 in FIG. 10. An additional feature depicted in this Figure is hose collar 46 which assists in connecting hose 16 to extension 40 of connector 11 by conventional technique.

FIG. 12 depicts an embodiment of the present invention attached to a faucet in a sink in a bathroom with also a tub/shower. This way, the sprayer/hose/connector assembly of the instant invention may be conveniently used to help wash and rinse children or pets in the tub, for example. Also, the assembly of the instant invention may also be conveniently used to help wash and rinse down the walls of the shower.

Although this invention has been described above with reference to particular means, materials, and embodiments, it is to be understood that the invention is not limited to these disclosed particulars, but extends instead to all equivalents within the scope of the following claims.

1. A water sprayer valve, hose and connector assembly for connection to the inside aerator threads on a faucet, comprising:
A generally cylindrical, hollow cup-like structure with an interior and exterior wall, the cup-like structure being threaded on the exterior wall near the cup-like structure's open top end, said threaded open top end being adapted to cooperate with the inside aerator threads, the bottom end of the cup-like structure being closed with a flat top surface except for a central, generally circular orifice;
A generally cylindrical insert structure which is adapted to fit inside the cup-like structure, the insert having a flat bottom which rests upon the flat top surface of the closed bottom end of the cup-like structure, the insert extending up to near the location of the threads at the top of the cup-like structure, and also being generally hollow for providing a central longitudinal opening which extends through the inside of the cup-like structure, including through its closed bottom end, the insert also having a generally cylindrical hollow extension which extends from its bottom end and is adapted to project down through the orifice in the bottom of the cup-like structure, with the hollow extension continuing the longitudinal opening, and having a distal end adapted for fitting into an end of a hose in conventional fashion; and
A generally cylindrical sealer washer adapted to fit inside the cup-like structure and rest on top of the insert structure so that it extends to slightly past the top of the cup-like structure, the sealer washer having a central, generally circular orifice which is generally co-extensive with the central longitudinal opening at the top of the insert structure.

2. The assembly of claim 1 which is adapted to receive alternate hose lengths on the hollow extension of the insert structure.

3. (canceled)

4. (canceled)

5. The assembly of claim 1 wherein the connector is threaded both at its top exterior and top interior walls.

6. The assembly of claim 1 wherein the connector has a knurled surface on the lower portion of its exterior wall.

7. A water sprayer valve, hose and connector assembly for connection to the outside aerator threads on a faucet, comprising:
A generally cylindrical, hollow cup-like structure with an interior and exterior wall, the cup-like structure being threaded on the interior wall near the cup-like structure's open top end, said threaded open top end being adapted to cooperate with the outside aerator threads, the bottom end of the cup-like structure being closed with a flat top surface except for a central, generally circular orifice:
A generally cylindrical insert structure which is adapted to fit inside the cup-like structure, the insert having a flat bottom which rests upon the flat top surface of the closed bottom end of the cup-like structure, the insert extending up to near the location of the threads at the top of the cup-like structure, and also being generally hollow for providing a central longitudinal opening which extends through the inside of the cup-like structure, including through its closed bottom end, the insert also having a generally cylindrical hollow extension which extends from its bottom end and is adapted to project down through the orifice in the bottom of the cup-like structure, with the hollow extension continuing the longitudinal opening, and having a distal end adapted for fitting into an end of a hose in conventional fashion; and
A generally cylindrical sealer washer adapted to fit inside the cup-like structure and rest on top of the insert structure so that it extends up a distance to about the location of the threads of the cup-like structure, the sealer washer having a central, generally circular orifice which is generally co-extensive with the central longitudinal opening at the top of the insert structure.

8. The assembly of claim 7 which is adapted to receive alternate hose lengths on the hollow extension of the insert structure.

9. The assembly of claim 7 wherein the connector is threaded both at its top exterior and top interior walls.

10. The assembly of claim 7 wherein the connector has knurled a surface on the lower portion of its exterior wall.
